(19) United States
(12) Patent Application Publication
(10) Pub. No.: US 2017/0322766 A1
(43) Pub. Date: Nov. 9, 2017

(54) METHOD AND ELECTRONIC UNIT FOR ADJUSTING PLAYBACK SPEED OF MEDIA FILES

(71) Applicant: Sony Mobile Communications Inc., Tokyo (JP)

(72) Inventor: Ola THÖRN, Limhamn (SE)

(21) Appl. No.: 15/589,100

(22) Filed: May 8, 2017

(30) Foreign Application Priority Data
May 9, 2016 (EP) 16168726.4

(51) Int. Cl. G06F 3/16; G10L 15/26; G06F 17/27

(52) U.S. Cl. CPC G06F 3/165; G06F 17/2785; G10L 15/26

(57) ABSTRACT

A method for adjusting speed of playback of at least a segment of a media file, comprising generating a text file by speech-to-text conversion of the media file; and determining a speed measure for the media file, including determining a plurality of speech elements in the text file, and associating a time stamp for each speech element of the generated text file. The method may further include determining a degree of comprehensibility of the media file; and adjusting a current speed of playback of the media file based on the determined speed measure and the determined degree of comprehensibility.

### RELATED APPLICATION DATA

This application claims priority to European Patent Application No. 16168726.4, filed May 9, 2016, the disclosure of which is incorporated herein by reference in its entirety.

### TECHNICAL FIELD

The present disclosure relates generally to media players that play media data. More specifically, the disclosure relates to method and unit for adjusting playback speed of media data.

### BACKGROUND

Media players exist with features that allow for playback of a media file at a rate that is faster than the normal rate. This permits the user to listen or watch podcast shows, media file, over a shorter period of time.

A common feature in media player apps is to be able to control the playback speed e.g. x1, x1.1, x1.2 etc. This feature helps the user to change the playback speed depending on the media file, category of content or specific show. Current podcasting apps allow the user to set the playback speed manually for each show and since a host may vary the speed they talk, word per minute (wpm), it is difficult to set the right playback speed. Furthermore, a guest may be on the show, talking at another speed and suddenly the set playback speed is not comprehensible to the listener.

### SUMMARY

With the above description in mind, then, an aspect of some embodiments of the present invention is to provide a method and unit for adjusting speed of playback of a media file, which seeks to mitigate, alleviate or eliminate one or more of the above-identified deficiencies in the art and disadvantages singly or in any combination.

The present disclosure is defined by the appended claims. Various advantageous embodiments of the disclosure are set for the by the appended claims as well as by the following description and accompanying drawings.

An aspect of the present invention relates to a method for adjusting speed of playback of at least a segment of a media file, comprising generating a text file by speech-to-text conversion of the media file; determining a speed measure for the media file, including determining a plurality of speech elements in the text file, and associating a time stamp for each speech element of the generated text file; determining a degree of comprehensibility of the media file; adjusting a current speed of playback of the media file based on the determined speed measure and the determined degree of comprehensibility.

In one embodiment, the step of adjusting the current speed of playback is based on a relation between the determined speed measure and a predetermined speed measure.

In one embodiment, the step of adjusting the current speed of playback includes changing to the speed of playback towards a playback speed associated with a predetermined speed measure.

In one embodiment, the step of determining a degree of comprehensibility includes computing a readability score from the text file based on a predetermined rule.

In one embodiment, the readability score is computed based on at least one of number of words per sentence, number of characters per word, number of long words, and word frequency.

In one embodiment, the readability score is computed based on a first measure comprising a calculated number of words per segment of words.

In one embodiment, the readability score is computed based on a combination of a first measure comprising a calculated number of words per segment of words; and a second measure associated with the number of characters per word.

In one embodiment, the degree of comprehensibility is determined based on a characteristic parameter of the media file associated with at least one of sound quality, language, dialect, topic and speaker.

In one embodiment, the step of adjusting the current speed of playback includes changing the speed of playback towards a playback speed associated with a predetermined speed measure, to a degree dependent on said readability score.

In one embodiment, the step of adjusting the current speed of playback includes changing the speed of playback to a pre-set playback speed associated with the determined degree of comprehensibility.

In one embodiment, the method comprises determining an intended playback user, wherein the step of adjusting a current speed of playback is carried out in accordance with a user-dependent rule.

In one embodiment, the step of determining a degree of comprehensibility includes determining a characteristic parameter of the media file associated with at least one of sound quality, language, dialect, topic and speaker of the media file; determining an intended playback user; determining a predetermined speed measure associated with the intended user; wherein the speed of playback is adjusted to accommodate to the predetermined speed measure.

In one embodiment, the method comprises identifying at least a first section and a second section of the media file; separately computing the readability score, determining the degree of comprehensibility, and adjusting the current speed of playback for said first segment and said second segment, respectively.

In one embodiment, the elements of speech is any of syllables, words, characters or part of words.

In one embodiment, the method comprises identifying parts of the generated text file where the degree of comprehensibility differs; and adjusting a current speed of playback of the identified parts of the media file to a pre-set speed of playback based on the determined degree of comprehensibility.

In one embodiment, the adjusting of current speed of playback is performed continuously and/or automatically.

Another aspect of the present invention relates to an electronic unit for adjusting speed of playback of a media file, comprising a processing circuitry, and a memory holding computer readable program code, which, when executed by the processing circuitry, causes the electronic device to generate a text file by speech-to-text conversion of the media file; determine a speed measure for the media file, including determining a plurality of speech elements in the text file, and associating a time stamp for each speech element of the generated text file; determine a degree of comprehensibility of the media file; and adjust a current speed of playback of the media file based on the determined speed measure and the determined degree of comprehensibility.

In one embodiment, the execution of the computer readable program code causes the electronic device to compute a readability score from the text file based on a predetermined rule.

In one embodiment, the execution of the computer readable program code causes the electronic device to adjust a current speed of playback by changing the speed of playback towards a playback speed associated with a predetermined speed measure, to a degree dependent on said readability score.

In one embodiment, the execution of the computer readable program code causes the electronic device to determine an intended playback user, wherein the step of adjusting a current speed of playback is carried out in accordance with a user-dependent rule.

The playback speed of a media file may thus be adjusted depending of the character of the content of the media file, thus the user gets the experience that all media files a played in a good continuous tempo.

An aspect of the present invention relates to a computer readable program, which, when executed on a communication device, causes the communication device to perform the method as described above.

It is an advantage with some embodiments of the invention that they may allow for improving that the user or listener captures all of the content of the media file.

The features of the above-mentioned embodiments can be combined in any combinations.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 is a flowchart illustrating the method according to the present invention.

FIG. 2 illustrates an example of an electronic unit according to the present invention.

### DETAILED DESCRIPTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Embodiments of the present invention will be exemplified using a wireless communication device such as a mobile phone. However, it should be appreciated that the invention is as such equally applicable to any device which have a media player. Examples of such devices may for instance be any type of mobile phone, smartphone, laptop (such as standard, ultra-portables, netbooks and micro laptops), handheld computers, tablet computers, touch pads, gaming devices, watches, wearables.

Unless otherwise defined, all terms (including and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

This invention proposes a method using a speech-to-text algorithm to calculate elements of speech, e.g. words, per time unit to set a global playback speed of a media file, e.g. a podcast. This may give the user an experience that all media files are played back in a good continuous speed. No matter on which media file, topic or how fast they speak in the show and the user only needs to set the speed of playback once.

In other embodiments variable depending on how difficult the content is to comprehend, e.g. due to wordings, topics, language, speaker, dialect.

In other embodiments, the speed of playback is mapped towards e.g. recording quality, language and dialect so that the speed of playback automatically changes e.g. depending on if it is difficult to hear.

As an example, podcast show A has a host that speaks really “slooooowllllyyyy” and show B has a host that speaks “really fast”. The speed for each show may be adjusted and thereby enhance the possibilities for the user or listener to capture all of the content.

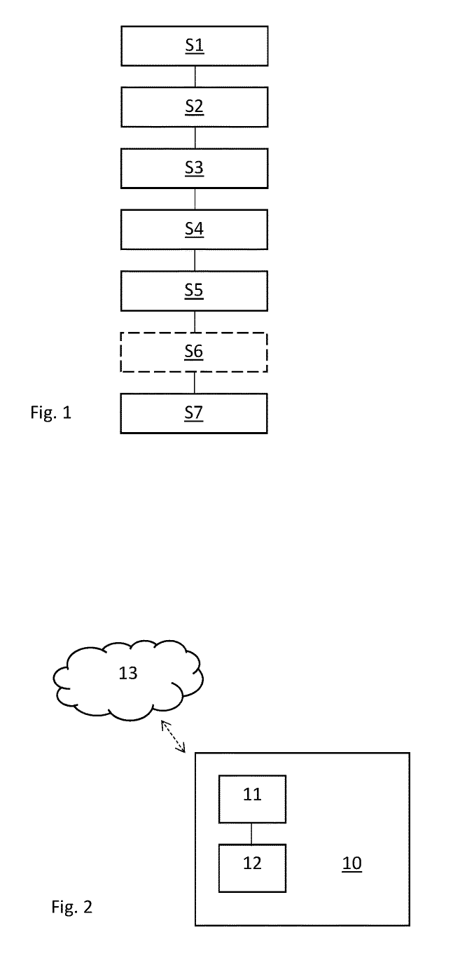

FIG. 1 is flow diagram depicting example operations which may be taken by an electronic unit 10 of FIG. 2, comprising a processing circuitry 11. The media file is stored in an internal storage 12 of the electronic unit 10 or in an external storage 13, e.g. cloud storage. The electronic unit may form part of a wireless device, or of a node or server in a communications network, accessible to user devices by means of said communications network.

According to some aspects of one embodiment, the method for adjusting speed of playback of a media file, comprises generating S1 an associate text file by a speech-to-text conversion of the media file. According to some aspects, the processing circuitry 11 is configured to generate the associated text file by the speech-to-text conversion of the media file. As an example, the media file is a podcast and an associated text file is generated by converting the podcast to text by using a speech-to-text service, e.g. IBM, Watson, cloud based or performed in an electronic device. The media file may also be any of a clean audio file or a video file.

The embodiment may further comprise determining S2 a speed measure for the media file. This may involve associating a time stamp for each elements of speech of the generated text file, and calculating S3 the number of elements of speech per time unit by using the associated time stamp, i.e. the current speed of speech is calculated. The elements of speech may be any of e.g. syllables, words, characters or part of words.

The embodiment may further comprise determining S4 the degree of comprehensibility of the media file. This may be carried out by means of determining S5 one or more characteristic parameters of the media file. The embodiment may also comprise adjusting S7 a current speed of playback of the media file based on the determined speed measure, and the determined degree of comprehensibility. The adjustment may e.g. be made to a pre-set speed of playback based on calculated number of elements of speech per time unit and the determined degree of comprehensibility.

In some aspects the processing circuitry 11 is configured to associate the time stamp for each elements of speech of the generated text file, calculate the number of elements of speech per time unit by using the associated time stamp, determine the degree of comprehensibility of the media file by means of determine characteristic parameters of the media file and adjust a current speed of playback of the media file to a pre-set speed of playback based on calculated number of elements of speech per time unit and the determined degree of comprehensibility.

According to some embodiments, the method may further comprise identifying S6 parts of the generated text file where the degree of comprehensibility differs and adjusting S7 a current speed of playback of the identified parts of the media file to a pre-set speed of playback based on the calculated number of elements of speech per time unit and the determined degree of comprehensibility.

In one embodiment, the step of adjusting the current speed of playback may be based on a relation between the determined speed measure and a predetermined speed measure. The predetermined speed measure may be associated with an intended user, e.g. a particular identified listener, of the media file. Alternatively, the predetermined speed measure may be associated with an intended user related to a theoretical group or character of intended listeners, such as a user of a certain language skill, nationality, academic degree etc.

In one embodiment, the step of adjusting the current speed of playback includes changing to the speed of playback towards a playback speed associated with such a predetermined speed measure. In a simple embodiment, the adjustment may simply be made to accommodate the playback speed to the predetermined speed measure, e.g. if the degree of comprehensibility is not determined to be a factor for affecting the playback speed. In a variant of this embodiment, the step of adjusting the current speed of playback may include changing the speed of playback towards a playback speed associated with a predetermined speed measure, to a degree dependent on said readability score. As an example, the predetermined speed measure may indicate a suitable playback speed which is double the current playback speed. However, the determined degree of comprehensibility may be such that it affects the assumed understanding by the intended user. The playback speed may then be increased by a lower degree than doubling, e.g. by only 50%.

The degree of comprehensibility may be determined based on a characteristic parameter of the media file associated with at least one of sound quality, language, dialect, topic and speaker.

In one embodiment, the step of adjusting the current speed of playback may be carried out by changing the speed of playback to a pre-set playback speed associated with the determined degree of comprehensibility.

In one embodiment, the method may involve determining an intended playback user. As noted, this may relate to stored data associated with a particular person or persons. Alternatively, it may be related to a group of people associated with a certain set of qualifications or capabilities associated with the ability to comprehend a played media file. In a variant of this embodiment, a user desirous to hear a media file may select a number of capability parameters related to e.g. language, dialect, topic etc., and thereafter be associated with a certain user characteristic. The step of adjusting a current speed of playback may be carried out in accordance with a user-dependent rule, associated with the determined intended user.

According to some aspects the degree of comprehensibility may be involve determining a parameter associated with at least one of a readability level or readability score, language, dialect, topic and/or speaker. According to some aspects, the readability score further comprises determining at least one of number of sentence, number of long words, length of sentences and word frequency.

In one embodiment, determining a degree of comprehensibility includes computing a readability score from the text file based on a predetermined rule. The readability score may be computed based on at least one of number of words per sentence, number of characters per word, number of long words, and word frequency.

In one embodiment, the readability score is computed based on a first measure comprising a calculated number of words per segment of words, where the segment may e.g. be sentences, or groups or periods of words separated by a period, colon or capital first letter.

More specifically, the readability score may in various embodiment be computed based on a combination of a first measure comprising a calculated number of words per segment of words, and a second measure associated with the number of characters per word. This will provide a value associated with a theoretical readability level, used in various forms in the art. There are several known types of readability measure or score that may be used to indicate the difficulty of reading a text, based on this principle. One example is LIX, which is a readability measure developed by a Swedish scholar. It is computed as follows:

LIX=A/B+(C*100)/A

A is the number of words, B is the number of periods, defined by period, colon or capital first letter and C is the number of long words, more than 6 letters.

Another example is automated readability index, ARI, which is a readability test for English texts, Flesch-Kincaid grade level, Gunning fog index, SMOG index, Fry readability formula and Cole-Liau index. The formula for calculating the automated readability index is given below:

ARI=4.71(characters/words)+0.5(words/sentences)−21.43

Measure or score of readability may also be based on the topics of media file, e.g. news, technical, novels, the language spoken in the media file, e.g. English, Swedish, Chinese, or the dialect of the language spoken in the media file.

The speed of playback of the media file, e.g. podcast, is then set based on the score of readability.

In one embodiment, if the text is defined as difficult the speed of playback is set to a speed associated with a first predetermined speed measure, Speed 1. If the text is defined as easy the speed of playback is to a playback speed associated with another predetermined speed measure, Speed 2. Thus, the user or listener may get the experience that all media files, such as podcasts, are played back in a good continuous tempo, no matter on which media file, which topic, or how fast they speak in the media file. The user only needs to set the tempo once, which may e.g. be stored as a user-dependent rule. A media player interface may preferably also include a user input object that may be operated to alter the playback speed, e.g. if the adjusted playback speed is not deemed to be appropriate by the user. In a preferred embodiment, such a manual adjustment will cause re-setting of the user-dependent rule, for future use.

In one embodiment, the method may comprise identifying at least a first section and a second section of the media file, and separately computing the readability score, determining the degree of comprehensibility, and adjusting the current speed of playback for said first segment and said second segment, respectively. This may be appropriate when a media file comprises spoken phrases of both a person speaking very fast and a person speaking very slow. The audio part in which only the slow-speaking person speaks may thereby be increased more than the audio part where the fast-speaking person speaks. Also, segments of audio representing longer pauses may be adjusted effectively than segments with speech. The method may thus involve identifying parts of a generated text file where the degree of comprehensibility differs; and adjusting a current speed of playback of the identified parts of the media file to a pre-set speed of playback based on the determined degree of comprehensibility.

In a preferred embodiment, the adjusting of current speed of playback is performed continuously and/or automatically.

FIG. 2 schematically illustrates an electronic unit 10 for adjusting speed of playback of a media file, comprising a processing circuitry 11, and a memory 12, such as a non-volatile memory, holding computer readable program code. As noted, the electronic unit 10 may form part of a wireless device, or of a node or server in a communications network, accessible to user devices by means of said communications network, such as by radio communications. According to various embodiments, the processing circuitry 11 is configured to execute program code in the memory 12, and thereby cause the electronic device to generate a text file by speech-to-text conversion of the media file; and determine a speed measure for the media file, including determining a plurality of speech elements in the text file and associating a time stamp for each speech element of the generated text file; determine a degree of comprehensibility of the media file; and adjust a current speed of playback of the media file based on the determined speed measure and the determined degree of comprehensibility.

With reference to the different embodiments outlined above, the electronic device may also be caused, by the execution of the computer readable program code in the processing circuitry 11, to compute a readability score from the text file based on a predetermined rule.

The electronic device may further be caused to adjust a current speed of playback by changing the speed of playback towards a playback speed associated with a predetermined speed measure, to a degree dependent on said readability score.

In one embodiment, the execution of the computer readable program code may cause the electronic device to determine an intended playback user, wherein the step of adjusting a current speed of playback is carried out in accordance with a user-dependent rule.

The various aspects of the disclosure described herein are described in the general context of method steps or processes, which may be implemented according to some aspects by a computer readable program, comprising computer readable code which, when run on a communication device, causes the communication device to perform the one or several of the methods according to above. The computer program, embodied in a computer-readable medium, includes computer-executable instructions, such as program code, executed by computers in networked environments. A computer-readable medium may include removable and non-removable storage devices 5 including, but not limited to, Read Only Memory, ROM, Random Access Memory, RAM, compact discs, CDs, digital versatile discs, DVD, etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

It should be appreciated that the operations, shown in FIG. 1, need not be performed in order. Furthermore, it should be appreciated that not all of the operations need to be performed.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims, that the aspects of the disclosure may be implemented at least in part by means of both hardware and software, and that several “means” or “devices” may be represented by the same item of hardware.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

What is claimed is:

1. A method for adjusting speed of playback of at least a segment of a media file, comprising:
generating a text file by speech-to-text conversion of the media file;
determining a speed measure for the media file, including
determining a plurality of speech elements in the text file;
associating a time stamp for each speech element of the generated text file;
determining a degree of comprehensibility of the media file;
adjusting a current speed of playback of the media file based on the determined speed measure and the determined degree of comprehensibility.

2. The method of claim 1, wherein the step of adjusting the current speed of playback is based on a relation between the determined speed measure and a predetermined speed measure.

3. The method of claim 1, wherein the step of adjusting the current speed of playback includes changing to the speed of playback towards a playback speed associated with a predetermined speed measure.

4. The method of claim 1, wherein the step of determining a degree of comprehensibility includes computing a readability score from the text file based on a predetermined rule.

5. The method of claim 4, wherein the readability score is computed based on at least one of number of words per sentence, number of characters per word, number of long words, and word frequency.

6. The method of claim 4, wherein the readability score is computed based on a first measure comprising a calculated number of words per segment of words.

7. The method of claim 4, wherein the readability score is computed based on a combination of
a first measure comprising a calculated number of words per segment of words; and
a second measure associated with the number of characters per word.

8. The method of claim 1, wherein the degree of comprehensibility is determined based on a characteristic parameter of the media file associated with at least one of sound quality, language, dialect, topic and speaker.

9. The method of claim 4, wherein the step of adjusting the current speed of playback includes changing the speed of playback towards a playback speed associated with a predetermined speed measure, to a degree dependent on said readability score.

10. The method of claim 1, wherein the step of adjusting the current speed of playback includes changing the speed of playback to a pre-set playback speed associated with the determined degree of comprehensibility.

11. The method of claim 1, comprising
determining an intended playback user,
wherein the step of adjusting a current speed of playback is carried out in accordance with a user-dependent rule.

12. The method of claim 1, wherein the step of determining a degree of comprehensibility includes
determining a characteristic parameter of the media file associated with at least one of sound quality, language, dialect, topic and speaker of the media file;
determining an intended playback user;
determining a predetermined speed measure associated with the intended user;
wherein the speed of playback is adjusted to accommodate to the predetermined speed measure.

13. The method of claim 1, comprising
Identifying at least a first section and a second section of the media file;
separately computing the readability score, determining the degree of comprehensibility, and adjusting the current speed of playback for said first segment and said second segment, respectively.

14. The method according to claim 1, wherein the elements of speech is any of syllables, words, characters or part of words.

15. The method of claim 1, comprising
identifying parts of the generated text file where the degree of comprehensibility differs; and
adjusting a current speed of playback of the identified parts of the media file to a pre-set speed of playback based on the determined degree of comprehensibility.

16. The method of claim 1, wherein the adjusting of current speed of playback is performed continuously and/or automatically.

17. An electronic unit for adjusting speed of playback of a media file, comprising a processing circuitry, and a memory holding computer readable program code, which, when executed by the processing circuitry, causes the electronic device to:
generate a text file by speech-to-text conversion of the media file;
determine a speed measure for the media file, including
determining a plurality of speech elements in the text file;
associating a time stamp for each speech element of the generated text file;
determine a degree of comprehensibility of the media file;
adjust a current speed of playback of the media file based on the determined speed measure and the determined degree of comprehensibility.

18. The electronic device of claim 17, wherein the execution of the computer readable program code causes the electronic device to
compute a readability score from the text file based on a predetermined rule.

19. The electronic device of claim 17, wherein the execution of the computer readable program code causes the electronic device to
adjust a current speed of playback by changing the speed of playback towards a playback speed associated with a predetermined speed measure, to a degree dependent on said readability score.

20. The electronic device of claim 17, wherein the execution of the computer readable program code causes the electronic device to
determine an intended playback user, wherein the step of adjusting a current speed of playback is carried out in accordance with a user-dependent rule.
